(19) United States
(12) Patent Application Publication
(10) Pub. No.: US 2022/0288514 A1
(43) Pub. Date: Sep. 15, 2022

(54) SYSTEMS AND PROCESSES FOR FILTERING WATER WITH ULTRAFINE GRANULAR MEDIA

(71) Applicants: Derek FRENCH, Toronto (CA); THE UNIVERSITY OF NORTH CAROLINA AT CHARLOTTE, Charlotte, NC (US)

(72) Inventors: James E. AMBURGEY, Kannapolis, NC (US); Derek FRENCH, Toronto (CA)

(21) Appl. No.: 17/825,847

(22) Filed: May 26, 2022

Related U.S. Application Data
(63) Continuation-in-part of application No. 16/148,660, filed on Oct. 1, 2018, now abandoned.
(60) Provisional application No. 62/565,231, filed on Sep. 29, 2017.

(51) Int. Cl. B01D 39/06; B01D 24/10; C02F 1/00

(52) U.S. Cl. CPC B01D 39/06; B01D 24/105; C02F 1/004; C02F 2303/04; C02F 2103/42

(57) ABSTRACT

A system for filtering water is described herein, the system comprising a granular filter media having an effective size of 0.05 mm to 0.4 mm. In some embodiments, a granular filter media described herein comprises a ceramic, a sand, a glass, a zeolite, a garnet, an anthracite coal, an activated carbon, an ilmentite, or any combination thereof. In some instances, a layer of granular filter media described herein has a flow rate from 2 to 12 gpm/ft², and is capable of filtering out materials having an average size in three dimensions of 1 μm or larger without requiring any type of coagulation to alter the surface properties of the particles.

### RELATED APPLICATION DATA

This application is a continuation-in-part of U.S. patent application Ser. No. 16/148,660 filed Oct. 1, 2018, which claims priority under 35 U.S.C. § 119(e) to U.S. Provisional Patent Application No. 62/565,231, filed Sep. 29, 2017, the contents of each of which are herein incorporated by reference in their entirety.

### FIELD

The invention is generally related to water filtration, and more specifically, to pool water filtration using ultrafine granular filter media.

### BACKGROUND

There are three common types of filters in use in swimming pools worldwide-sand-based depth filters, membrane-based cartridge filters, and surface filtration-based precoat filters. Sand-based filters typically contain a layer of sand having an effective size of 0.4-0.8 mm with a typical depth (length) of 10-40 inches. Sand filters are often referred to as depth filters, which generally capture contaminants within the filtering media itself, as opposed to membrane and precoat filters, which typically trap contaminants on a surface of the filtering media. Generally, depth filters can retain a high load of contaminant particles that clog slowly throughout the depth of the filter bed over time. Protozoan parasite removal in a sand filter is generally 20-50% per pass without chemical pretreatment.

Membrane-based cartridge filters typically use a pleated membrane material having an average pore size of 30 microns. Removal of particles in the size range of protozoan parasites (˜4.5 microns) is typically 10-40% per pass for membrane-based cartridge filters of 30 micron. While membrane-based filters can filter out very small particles, their useful lifespan is short, because once the pores on the surface become clogged with particulates, the filter has to be changed.

Precoat filters use a much finer filter media than depth filters, usually a powder having an effective size of 0.03 to 0.05 mm. This fine of a filter media is often used at a media depth of only 1/16″ to ⅛″. Precoat filtration is typically called surface filtration since the media depth is usually less than or equal to ⅛-inch, and can achieve 4.5 micron particle removals in excess of 99%. The disadvantage of precoat filtration is that the very small particle sizes of the powdered filtration media can lead to dense packing that can quickly become clogged by contaminant particles, and the relative thinness of the precoat media layer means that the media layer has a very small loading contaminant loading capacity, so contaminants can leach out. Additionally, since the precoat media is often a powder, replacement of the spent precoat media can present an inhalation hazard.

Attempts to use precoat filtration media as a primary material in depth filters, rather than larger-sized sand, have been largely unsuccessful. The ultrafine, powdered precoat filtration media exhibits high packing density, which dramatically increases the tortuosity for passing water, which in turn, dramatically reduces water flow rates through the media as the thickness of the media increases. Moreover, the ultrafine powders of precoat filtration media are difficult to contain within high-flow filters, and often escape into pools, spas, and other recreational waters.

Therefore, there remains a need for improved filtration media, including for applications involving the purification of water for recreational use.

### SUMMARY

A filtering system is described herein that has a pathogen removal capability similar to that of a precoat filter, with one or more advantages of a depth filter, such as a high particle loading capacity, reusable filter media, no inhalation hazards of a silica powder, simple operation, and easy maintenance.

In one aspect, a system for filtering water can comprise a granular filter media having an effective size of 0.05 mm to 0.4 mm. A granular filter media described herein can comprise a ceramic, a sand, a glass, a zeolite, a garnet, an ilmentite, or any combination thereof. The granular filter media can have a zero or positive zeta potential at neutral pH, and can have an approximately spherical shape

A granular filter media described herein can in some instances comprise a plurality of surface pores having a diameter of 500 nm to 75 μm. In some instances, a layer of granular filter media can filter water having a flow rate of up to 12 gpm/ft², for instance from 2-12 gpm/ft². In some embodiments, a granular filter media has a porosity of 30% to 55%.

In some embodiments, a system described herein can comprise a downstream layer comprising the granular filter media; and an upstream layer comprising a low density filter media having an effective size (e.g. effective particle size) that is larger than the effective size of the granular filter media. A low density filter media described herein can have an effective size of 0.45 mm or larger, and in some instances, can comprise a carbonaceous material, a sand, a glass, a zeolite, a ceramic, or any combination thereof.

In another aspect, a method of filtering water is described herein, and comprises passing water through a layer of granular filter media described herein having an effective size of 0.05 mm to 0.4 mm; and filtering out materials having an average size in three dimensions of 1 μm or larger. In some instances, the water is passed through a layer of granular filter media described herein at a rate of up to 12 gpm/ft². In some instances, it will be appreciated that the water to be passed through the layer of granular filter media has a velocity of up to 12 gpm/ft².

In some embodiments, a method of filtering water is described herein, and comprises passing water through a filter system comprising a column and a layer of granular filter media, wherein the hydraulic loading rate of the water in the column above the layer of granular filter media is at least 2 gpm/ft² and wherein the particles of the layer of granular filter media have a size of 0.10 mm to 0.40 mm, and filtering out materials having an average size in three dimensions of 1 μm or larger. In some instances, 90% of the particles of the layer of granular filter media are larger than 0.15 mm and smaller than 0.35 mm.

In some embodiments, a method of filtering water is described herein, and comprises passing water through a filter system comprising a column and a layer of granular filter media, wherein the hydraulic loading rate of the water in the column above the layer of granular filter media is at least 2 gpm/ft² and wherein the particles of the granular filter media have an effective size of 0.05 mm to 0.40 mm.

In some embodiments, a layer of granular filter media is a downstream layer and a layer of low density filter media is an upstream layer.

In some instances, materials filtered out by a method described herein include microorganisms comprising Cryptosporidium ssp, Giardia ssp, or both. In some embodiments, a step of filtering of materials occurs in an absence or presence of chemical pretreatment.

### BRIEF DESCRIPTION OF THE DRAWINGS

Aspects of the technology presented herein are described in detail below with reference to the accompanying drawing figures, wherein:

FIG. 1 is a scanning electron microscope (SEM) image of example granular filter media, in accordance with some aspects of the technology described herein;

FIG. 2 is an SEM image of an example ceramic-based granular filter media, in accordance with some aspects of the technology described herein;

FIG. 3 is an SEM image of an example glass microbead filter media, in accordance with some aspects of the technology described herein;

FIG. 4 is a sectional view of an example granular filter material packed in a column, in accordance with some aspects of the technology described herein;

FIG. 5 is a sectional view of an example column packed with a layer of granular filter material and a layer of low density filter material, in accordance with some aspects of the technology described herein;

FIG. 6 is a graphical illustration of filter effluent turbidity after using different types of filter media, in accordance with some aspects of the technology described herein;

FIG. 7 is a graphical illustration of effluent particle counts after using different types of filter media, in accordance with some aspects of the technology described herein;

FIG. 8 is a graphical illustration of head loss (average pressure drop) in columns packed with different types of filter media, in accordance with some aspects of the technology described herein;

FIG. 9 is a graphical illustration of 5-micron microsphere removal properties of ultrafine ceramic filter media verses zeolite, in accordance with some aspects of the technology described herein; and

FIG. 10 is an example filter system comprising a column and a granular filter media, in accordance with some aspects of the technology described herein.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of this disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Recreational water, as described herein is generally referred to as water used for recreational purposes, such as water used in recreational facilities, such as a pool, a hot tub, a spa, a water park, and other locations where water will be in contact with a user of the facility. Generally, recreational water is nonpotable water, which is water not fit for user consumption as drinking water. However, recreational water can be incidentally consumed by a user during use of a recreational facility, and therefore often must conform to minimum purity standards usually mandated by governmental entities.

Filter media, filtering systems, and/or methods of filtering water described herein overcome deficiencies in sand-based depth filters (e.g. slow sand filters), membrane-based cartridge filters, and surface filtration-based precoat filters, among others. For example, slow sand filters (and others) require the use of a biological layer, or a support means to enable the growth of a biological layer (in some instances called a schmutzdecke) that takes time to develop in the absence of chlorine. Additionally, filter media, filtering systems, and/or methods of filtering water described herein in some instances do not require a coagulant, and furthermore are chlorine compatible. Accordingly, in some embodiments, filter media, filtering systems, and/or methods, do not include a biological layer and/or do not include or require a coagulant.

### I. Filtering System

In an aspect, a system for filtering water is described herein. In some embodiments, a system for filtering water, such as swimming pool water or other recreational water, using an ultrafine granular filter media is described herein. It will be appreciated that the filter media, filtering systems, and methods of filtering water using the filter media described herein may be applied to any suitable water source, for instance, lake water, river water, well water, pool water, spa water, or water from a water tank. In some instances, the water to be filtered can come from a recreational water source, for example water used for recreational purposes such as pools, hot tubs, water parks and the like. In some instances, a system described herein can filter water to produce drinking water using an ultrafine granular filter media described herein. This system can in some instances significantly improve the removal of protozoan parasites known to cause waterborne disease outbreaks in swimming pools (such as Cryptosporidium and Giardia), produce cleaner, clearer pool water, and/or produce cleaner potable water. In some embodiments, a system described herein can be used without any chemical pretreatment to remove particles or microbes measuring 1 micron or greater in diameter. While a system described herein can be used without chemical pretreatment, in some cases the system can be compatible with chemical pretreatments such as the use of coagulants. In some embodiments, ultrafine granular filter media described herein can be used alone or in combination with larger filter media.

In some embodiments, a system for filtering water comprises a granular filter media. In some instances, a granular filter media described herein comprises a layer. A granular filter media can comprise a ceramic, a sand, a glass, a zeolite, a garnet, an ilmentite, or any combination thereof.

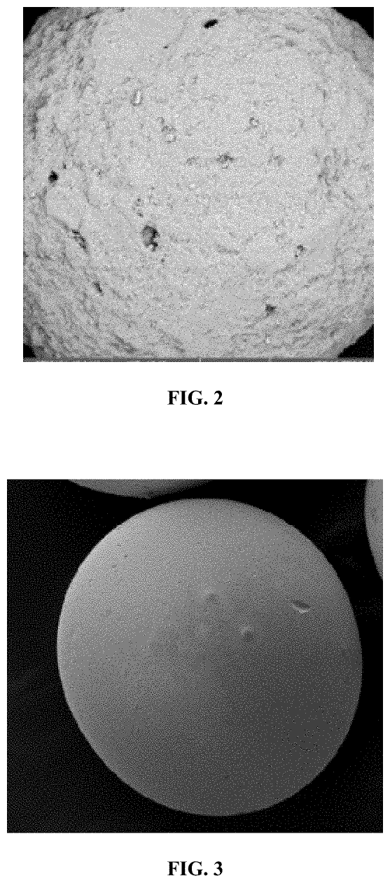

In some embodiments, a granular filter media described herein comprises a surface roughness that is greater than a surface roughness of other common filtering media. An increased surface roughness of the granular filter media over a comparatively smooth crystalline surface of other common filtering media can exhibit increased contaminant particle attachment potential to the granular filter media through increased surface are per unit volume, and/or greater adhesion potential of contaminant particles to the surface of a granular filter media. As an example, FIG. 2 shows a scanning electron microscope (SEM) image of an exemplary granular ceramic filter media having a surface roughness that is comparatively greater than a glass-based microbead filter media shown in FIG. 3.

In some instances, a granular filter media described herein can be a granule or particle, or ultrafine granule or particle, where grain size or particle size is expressed as an effective size. As will be appreciated by one of skill in the art, an effective size as described herein is a particle size based on a sieve opening where 10% of the particles in a sample (e.g. filter media) by total weight or mass basis are finer/smaller, while 90% are larger. In some instances, the size can be the diameter of the particles. This is typically referred to as “D10” or “Effective Size” in the field of art. With respect to expressing the filter media described herein in terms of an effective size, it would be appreciated by those of skill in the art that granular filter media does not come in a single size but rather in a distribution of sizes. The size distribution of granular filter media can be characterized by an effective size (ES) and/or a uniformity coefficient (UC) based on results obtained from a sieve analysis, for example ASTM C136-06. As described above, the ES is the estimated size that would have 10% of the total weight or mass of the media sample (e.g. granules or particles of a filter media) being smaller (than the ES), which is called D10, which is the particle dimension for which 10% of the total weight or mass of the media sample (e.g. granular filter media) is smaller than. Similarly, a D60 size is the particle size below which 60% of the media sample weight or mass is smaller than. Dividing the D60 by the D10, a UC can be determined, that is UC=D60/D10. As will be appreciated, in some instances, effective size refers to a total sample (e.g. a granular filter media) and not individual particle sizes.

According to some embodiments, a granular filter media described herein can have an effective size (i.e. effective particle size) of 0.05 to 0.4 mm, 0.1 to 0.4 mm, 0.15 to 0.4 mm, 0.2 to 0.4 mm, 0.25 to 0.4 mm, 0.3 to 0.4 mm, 0.35 to 0.4 mm, 0.05 to 0.35 mm, 0.05 to 0.3 mm, 0.05 to 0.25 mm, 0.05 to 0.2 mm, 0.05 to 0.15 mm, 0.05 to 0.1 mm, 0.10 to 0.3 mm, 0.15 to 0.25 mm, 0.20 to 0.40 mm, or 0.25 to 0.35 mm.

In some cases, a granular filter media has a particle size of 30 to 90 mesh, 40 to 80 mesh, 50 to 70 mesh, 60 to 80 mesh, or 40-60 mesh. In some other embodiments, a granular filter media can comprise a single average particle size. In some further embodiments, a granular filter media can comprise a mixture of two distinct average particle sizes. For example, in some instances a first granular filter media having a first effective size can be combined with a second granular filter media having a second effective size that is different from the first effective particle size.

In some other embodiments, a granular filter media described herein can comprise particles having a size of about 0.1 mm to about 0.4 mm, for example a size range of 0.15 to 0.4 mm, 0.2 to 0.4 mm, 0.25 to 0.4 mm, 0.3 to 0.4 mm, 0.35 to 0.4 mm, 0.05 to 0.35 mm, 0.05 to 0.3 mm, 0.05 to 0.25 mm, 0.05 to 0.2 mm, 0.05 to 0.15 mm, 0.05 to 0.1 mm, 0.10 to 0.3 mm, 0.15 to 0.25 mm, 0.20 to 0.40 mm, or 0.25 to 0.35 mm. In some example embodiments, a granular filter media can have 90% of the particles of a size larger than 0.15 mm and smaller than 0.35 mm. In some instances, particle or granule size is based on the diameter of a particle or granule.

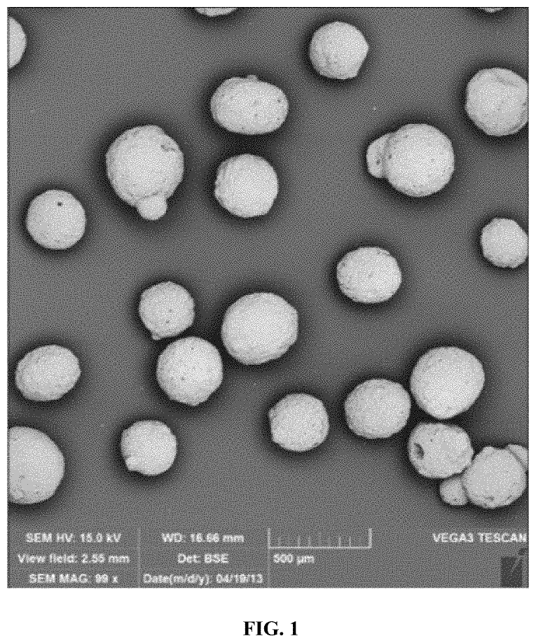

A granular filter media described herein can have any shape not inconsistent with the objectives of this disclosure. In some instances, a granular filter media can be approximately spherical, as shown for example in FIG. 1, which shows spherical granular ceramic filter media. A spherical granular filter media can in some embodiments display certain desirable physical properties over non-spherical filter media. For example, a spherical granular filter media can pack less densely than some angular media, which can offer improved hydraulics capacity, such as lower head loss. However, a granular filter media described herein is not solely limited to spherical granular filter media, but can in some embodiments can be triangular, cylindrical, squared, rectangular, hexagonal, or any other granular shape not inconsistent with the objectives of this disclosure.

In some embodiments, a granular filter media described herein can have a zero or positive zeta potential at neutral pH, for example at a pH from 6-8, in some instances at a pH of 7. In some instances, a granular filter media has a zeta potential of 0 to +30 mV, 0 to +25 mV, 0 to +20 mV, 0 to +15 mV, 0 to +10 mV, 0 to +9 mV, 0 to +8 mV, 0 to +7 mV, 0 to +6 mV, 0 to +5 mV, 0 to +4 mV, 0 to +3 mV, 0 to +2 mV, 0 mV, +1 mV, +2 mV, +3 mV, +4 mV, +5 mV, +6 mV, +7 mV, +8 mV, +9 mV, +10 mV, or greater than +10 mV. While not intending to be bound by theory, it is believed that granular filter media having a zero to positive zeta potential, such as ceramic-based granular filter media, can reduce electrostatic repulsion between negatively charged particles and a negatively charged filter media surface, thereby increasing particle removal.

A granular filter media described herein can comprise a plurality of surface pores in some embodiments, each surface pore having an opening diameter in a range 500 nm to 75 μm, 750 nm to 75 μm, 1 to 75 μm, 10 to 75 μm, 20 to 75 μm, 30 to 75 μm, 40 to 75 μm, 50 to 75 μm, 60 to 75 μm, 1 to 75 μm, 1 to 65 μm, 1 to 55 μm, 1 to 45 μm, 1 to 40 μm, 1 to 30 μm, 1 to 20 μm, or 1 to 15 μm.

In some embodiments, a granular filter media can have a porosity of 30 to 55%, where porosity is a volume of pores (empty space) divided by a total volume of granular filter media. In some instances, a granular filter media described herein can have a porosity of 35 to 55%, 35 to 50%, 35 to 45%, or 30 to 40%.

A granular filter media described herein can have a water flow rate of a volume sufficient for recreational water use, such as a flow rate sufficient to filter pool or spa water. In some cases, a granular filter media described herein can have a water flow rate of a volume sufficient for filtering drinking water. In some embodiments, a granular filter media can have a water flow rate or velocity of up to 1 gpm/ft², up to 2 gpm/ft², up to 3 gpm/ft², up to 4 gpm/ft², up to 5 gpm/ft², up to 6 gpm/ft², up to 7 gpm/ft², up to 8 gpm/ft², up to 9 gpm/ft², up to 10 gpm/ft², up to 11 gpm/ft², up to 12 gpm/ft², 1 to 12 gpm/ft², 2 to 12 gpm/ft², 3 to 12 gpm/ft², 4 to 12 gpm/ft², 5 to 12 gpm/ft², 6 to 12 gpm/ft², 7 to 12 gpm/ft², 8 to 12 gpm/ft², 9 to 12 gpm/ft², 10 to 12 gpm/ft², 10 to 12 gpm/ft², 8 to 10 gpm/ft², 7 to 11 gpm/ft², 7 to 10 gpm/ft², or 7 to 9 gpm/ft².

In some embodiments, a granular filter media can itself filter water, receive water, or have water applied to it, for example to be filtered, at a hydraulic loading rate (HLR) of 2 gpm/ft², up to 3 gpm/ft², up to 4 gpm/ft², up to 5 gpm/ft², up to 6 gpm/ft², up to 7 gpm/ft², up to 8 gpm/ft², up to 9 gpm/ft², up to 10 gpm/ft², up to 11 gpm/ft², up to 12 gpm/ft², 1 to 12 gpm/ft², 2 to 12 gpm/ft², 3 to 12 gpm/ft², 4 to 12 gpm/ft², 5 to 12 gpm/ft², 6 to 12 gpm/ft², 7 to 12 gpm/ft², 8 to 12 gpm/ft², 9 to 12 gpm/ft², 10 to 12 gpm/ft², 10 to 12 gpm/ft², 8 to 10 gpm/ft², 7 to 11 gpm/ft², 7 to 10 gpm/ft², or 7 to 9 gpm/ft². It will be appreciated that according to some aspects of the technology described herein, hydraulic loading rate can be defined as the flow rate per unit surface area of a filter bed, such as a granular filter media bed, which can also be understood to be a velocity of the water through a filter vessel above the filter media bed. In alternate units, the above velocity and/or hydraulic loading rates can be in metric units, i.e. m³/hr for flow divided by m² for surface area to yield m/hr. It will be appreciated that HLR can in some instances be referred to surface loading rate (SLR) or filter loading rate (FLR). In some embodiments, a granular filter media as described herein can filter water at a velocity consistent with the above hydraulic loading rates.

According to some further embodiments of the present technology, a filter or filtration system can comprise a column and a granular filter media within the column for the filtration of water. The filtration system can operate at a hydraulic loading rate of 2 gpm/ft², up to 3 gpm/ft², up to 4 gpm/ft², up to 5 gpm/ft², up to 6 gpm/ft², up to 7 gpm/ft², up to 8 gpm/ft², up to 9 gpm/ft², up to 10 gpm/ft², up to 11 gpm/ft², up to 12 gpm/ft², 2 to 12 gpm/ft², 3 to 12 gpm/ft², 4 to 12 gpm/ft², 5 to 12 gpm/ft², 6 to 12 gpm/ft², 7 to 12 gpm/ft², 8 to 12 gpm/ft², 9 to 12 gpm/ft², 10 to 12 gpm/ft², 10 to 12 gpm/ft², 8 to 10 gpm/ft², 7 to 11 gpm/ft², 7 to 10 gpm/ft², or 7 to 9 gpm/ft². It will be appreciated that in this instance, the hydraulic loading rate refers to the water rate (sometimes alternatively referred to as a velocity or a flow rate) in the column of a filter system (i.e. in the filter column) above the surface of the granular filter media bed. Accordingly, in some instances, a filter or filtration system can have a hydraulic loading rate from 2 gpm/ft² to 12 gpm/ft². In some example embodiments, water can be fed or supplied to a filter or filtration system described herein such that the hydraulic loading rate is from 2 gpm/ft² to 12 gpm/ft².

In some embodiments, a system described herein can comprise a layer of granular filter media. A layer of granular filter media can comprise a depth of at least 8 in, at least 9 in, at least 10 in, at least 11 in, at least 12 in, at least 13 in, at least 14 in, at least 15 in, at least 16 in, at least 17 in, at least 18 in, at least 19 in, at least 20 in, at least 25 in, at least 30 in, at least 35 in, at least 40 in, at least 45 in, greater than 50 in, 8 to 25 in, 10 to 25 in, 12 to 25 in, 15 to 25 in, 17 to 25 in, 20 to 25 in, 22 to 25 in, 8 in, 9 in, loin, 11 in, 12 in, 13 in, 14 in, 15 in, 16 in, 17 in, 18 in, 19 in, 20 in, 21 in, 22 in, 23 in, 24 in, or 25 in. In some example embodiments a layer of granular filter media can have a depth of 8 in to 60 in. In some further embodiments, a system described herein can comprise one or more layers of granular filter media.

In some embodiments, a layer of granular filter media described herein can filter out particles and microbes having an average size in three dimensions of less than 1 μm, 1 μm or larger, 2 μm or larger, 3 μm or larger, 4 μm or larger, 5 μm or larger, 6 μm or larger, 7 μm or larger, 8 μm or larger, 9 μm or larger, 10 μm or larger, 2 to 6 μm, 2 to 5 μm, 2 to 4 μm, 3 to 6 μm, or 4 to 6 μm. In some instances, a layer of granular filter media described herein can filter out particles and microbes having the above described average sizes with an efficiency of at least 50%, 60%, 70%, 80%, 85%, 90%, 95%, greater than 90%, or greater than 95%.

In some cases, a layer of granular filter media described herein can filter out particles and microbes 1 μm or larger with an efficiency of at least 90%. In some embodiments, a layer of granular filter media having a depth of at least 8 in, for example 8 in to 25 in, 8 in to 35 in, 8 in to 45 in, 8 in to 55 in, or 8 in to 60 in can filter out particles and microbes having a size of 1 μm or greater without the use of a coagulant or a biological layer, and at a flow rate or a hydraulic loading rate of from about 2 gpm/ft² to up to about 12 gpm/ft².

In some instances, a system described herein can further comprise one or more additional filtering media layers in combination with a granular filter media layer. For example, in some embodiments, a system can comprise a low density filter media or lower density filter media having an effective size that is larger than an effective size of the granular filter media. A low density filter media described herein can an effective size of 0.4 to 3 mm, 0.5 to 3 mm, 0.6 to 3 mm, 0.7 to 3 mm, 0.8 to 3 mm, 0.9 to 3 mm, 1 to 3 mm, 1.3 to 3 mm, 1.5 to 3 mm, 1.7 to 3 mm, 2 to 3 mm, 2.3 to 3 mm, 0.4 to 2.9 mm, 0.4 to 2.8 mm, 0.4 to 2.7 mm, 0.4 to 2.6 mm, 0.4 to 2.3 mm, 0.4 to 2 mm, 0.4 to 1.7 mm, 0.4 to 1.5 mm, 0.4 to 1.3 mm, 0.4 to 1 mm, 0.4 to 0.7 mm, 0.4 mm or larger, 0.5 mm or larger, 0.6 mm or larger, 0.7 mm or larger, 0.8 mm or larger, or 0.9 mm or larger. In some embodiments, a system can comprise a low density filter media having an effective size that is approximately equal to an effective size of a granular filter media.

A low (or lower) density filter media can comprise a carbonaceous material, a sand, a glass, a zeolite, a ceramic, or any combination thereof. Any carbonaceous material not inconsistent with the objectives of this disclosure can be used, such as anthracite coal, activated charcoal, and the like. A low density sand, glass, zeolite, or ceramic can be made of the same types of materials as a sand-, glass-, zeolite-, or ceramic-based granular filter media described herein, but can have a higher number of, or larger sized, pores than the granular filter media.

In some embodiments, a system described herein can comprise a downstream layer comprising a granular filter media; and an upstream layer comprising a low density filter media. As water passes through the upstream layer, larger particulates and materials can be filtered out prior to passing through the granular filter media. By removing these larger particulates and materials prior to the water passing through the granular filter media, the lifetime of the granular filter media can be extended, because the larger particulates and materials will not clog the pores and openings in the granular filter media layer. However, in other embodiments, a system described herein can comprise a downstream layer comprising a low density filter media; and an upstream layer comprising a granular filter media.

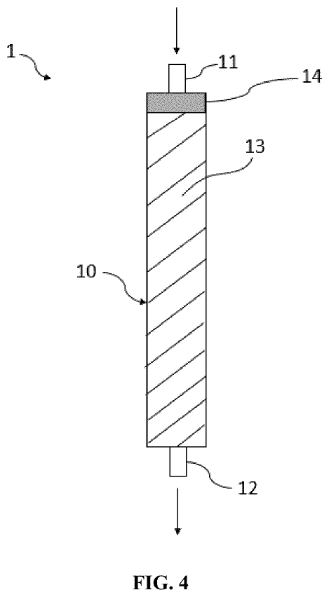

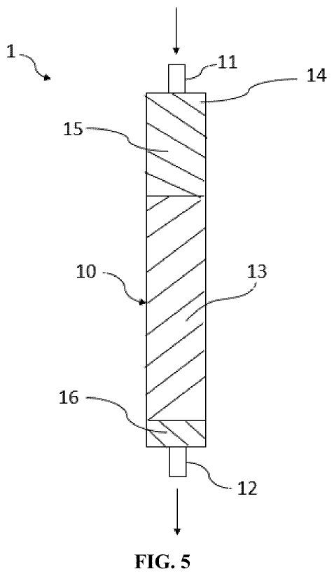

FIGS. 4 and 5 illustrate various systems described herein for filtering water. In some embodiments, a system 1 described herein can comprise a column 10 having an inlet 11 proximate a first end and an outlet 12 proximate an opposing second end. A column 10 can have a centrally located filter media receiving space for receiving filter media. Water flow is illustrated using arrows, where water enters inlet 11, passes through the filtering media, and exits through outlet 12. In some embodiments, an optional orifice plate 14 can be positioned proximate to a first end of column 10 to limit backwashing flow rates, or in other instances can be positioned proximate to a second end of column 10 to limit both backwashing and filtration rates. In some embodiments, an orifice plate 14 can be positioned proximate to both a first end and a second end of column 10. In some embodiments, an optional fine gravel layer 16 can being positioned between outlet 12 and filtering media in the filter media receiving space to prevent filtering media from exiting column 10 through outlet 12.

In an embodiment shown in FIG. 4, a single type granular filter media 13 described herein is positioned in a filter media receiving space of column 10. An optional orifice plate 14 is positioned proximate to a first end of the column 10. A fluid, such as recreational water, enters into the column 10 through inlet 11, passes through the granular filter media 13, and exits through outlet 12. While not shown, an optional fine gravel layer can be positioned between the granular filter media 13 and outlet 12, and/or a second orifice plate can be positioned proximate to a second end of column 10.

In an embodiment shown in FIG. 5, a layer of granular filter media 13 is positioned in the filter media receiving space of column 10 as a downstream layer, and a layer of low density filter media 15 forms an upstream layer. An optional fine gravel layer 16 is positioned between outlet 12 and the granular filter media 13 layer. A fluid, such as water, enters into the column 10 through inlet 11; passes through the low density filter media 15, granular filter media 13 and optional gravel layer 16; and exits through outlet 12. While not shown, an optional orifice plate 14 can be positioned between the low density filter media 15 layer and inlet 11, and/or between the granular filter media 13 layer and outlet 12.

In some instances, a system described herein, such as the system described in FIG. 4 or 5, can comprise column 10 connected to a swimming pool, where recreational water from the swimming pool enters into column 10 through inlet 11, is filtered through at least a layer of granular filter media 13, exits column 10 through outlet 12, and is discharged back into the swimming pool.

In some instances, a system described herein, such as the system described in FIG. 4 or 5, can comprise column 10 connected to a hot tub or spa, where recreational water from the hot tub or spa enters into column 10 through inlet 11, is filtered through at least a layer of granular filter media 13, exits column 10 through outlet 12, and is discharged back into the hot tub or spa.

In some embodiments, a system described herein, such as the system described in FIG. 4 or 5, can comprise column 10 connected to a water source, where water from the water source enters into column 10 through inlet 11, is filtered through at least a layer of granular filter media 13, exits column 10 through outlet 12, and potable drinking water is discharged from column 10.

An example of a conventional drinking water filtration system is a tri-media filter comprising a 3 to 4 in layer of garnet having an effective size of 0.2 to 0.3 mm, a 12 in sand layer, and a 24 in anthracite layer. This conventional tri-media filter cannot remove pathogens with an efficiency of at least 90% without chemical pretreatment (or coagulation), but instead requires chemical pretreatment with a coagulant to be effective. Additionally, this conventional tri-media filter has very low flow rates, such as an upper limit of 4 gpm/ft².

In contrast to the conventional tri-media filter, a system described herein for filtering water can remove pathogens such as Crypto without requiring coagulation and/or other pretreatment of water, and can do so at a high flow rate and/or high hydraulic loading rate, such as 12 gpm/ft², for example from 2-12 gpm/ft². Moreover, in some embodiments, a system described herein can filter pathogens at a high flow rate and/or a high hydraulic loading rate using a layer of ultrafine granular filter media described herein at a depth at least double that of the garnet layer in a conventional tri-media filter for potable water. A garnet layer has an equivalent depth would have very low flow rates, and would still require coagulants to be effective. A layer of ultrafine granular filter media can have a depth as little as 8 inches to be effective at removing Crypto with 90% efficiency at high flow rates, compared to a 40 in overall depth of the conventional tri-media filter for drinking water (that requires coagulation) at low flow rates and low hydraulic loading rates.

### II. Method of Filtering Water

In another aspect, a method of filtering water is described herein. In some embodiments, a method of filtering water comprises passing water through a layer of granular filter media described in Section I, the granular filter media having an effective size of 0.05 mm to 0.4 mm; and filtering out particles having an average size in three dimensions of 1 μm or larger. The water being filtered can be any water source not inconsistent with the objectives of this disclosure. In some instances, the water being passed and filtered is recreational water.

In some embodiments, water is passed through a layer of granular filter media at a rate of up to 12 gpm/ft², 7-11 gpm/ft², 7-10 gpm/ft², 7-9 gpm/ft², 7-8 gpm/ft², 8-12 gpm/ft², 9-12 gpm/ft², 10-12 gpm/ft², 11-12 gpm/ft², 7 gpm/ft², 8 gpm/ft², 9 gpm/ft², 10 gpm/ft², 11 gpm/ft², or 12 gpm/ft².

According to further some embodiments, a method of filtering water comprises passing water through a filter system, the filter system comprising a column and a layer of granular filter media. The water (i.e. the water to be filtered) can be passed to the filter or filtration system such that the hydraulic loading rate of the water in the column above the layer of granular filter media is at least 2 gpm/ft² and up to 12 gpm/ft², for example 2 gpm/ft², up to 3 gpm/ft², up to 4 gpm/ft², up to 5 gpm/ft², up to 6 gpm/ft², up to 7 gpm/ft², up to 8 gpm/ft², up to 9 gpm/ft², up to 10 gpm/ft², up to 11 gpm/ft², up to 12 gpm/ft², 3 to 12 gpm/ft², 4 to 12 gpm/ft², 5 to 12 gpm/ft², 6 to 12 gpm/ft², 7 to 12 gpm/ft², 8 to 12 gpm/ft², 9 to 12 gpm/ft², 10 to 12 gpm/ft², 10 to 12 gpm/ft², 8 to 10 gpm/ft², 7 to 11 gpm/ft², 7 to 10 gpm/ft², or 7 to 9 gpm/ft².

As previously described in Section I, a method described herein can in some embodiments filter out particles and microbes having an average size in three dimensions of less than 1 μm, 1 μm or larger, 2 μm or larger, 3 μm or larger, 4 μm or larger, 5 μm or larger, 6 μm or larger, 7 μm or larger, 8 μm or larger, 9 μm or larger, 10 μm or larger, 2 to 6 μm, 2 to 5 μm, 2 to 4 μm, 3 to 6 μm, or 4 to 6 μm. In some instances, a method described herein can filter out particles and microbes having the above described average sizes with an efficiency of at least 50%, 60%, 70%, 80%, 85%, 90%, 95%, greater than 90%, or greater than 95%. In some cases, a method described herein can filter out particles and microbes 1 μm or larger with an efficiency of at least 90%.

According to some embodiments, a method of filtering water comprises passing water through the granular filter media, comprising particles having a size of about 0.1 mm to about 0.4 mm, for example a size range of 0.15 to 0.4 mm, 0.2 to 0.4 mm, 0.25 to 0.4 mm, 0.3 to 0.4 mm, 0.35 to 0.4 mm, 0.05 to 0.35 mm, 0.05 to 0.3 mm, 0.05 to 0.25 mm, 0.05 to 0.2 mm, 0.05 to 0.15 mm, 0.05 to 0.1 mm, 0.10 to 0.3 mm, 0.15 to 0.25 mm, 0.20 to 0.40 mm, or 0.25 to 0.35 mm. In some example embodiments, a granular filter media can have 90% of the particles (e.g. by weight, mass, amount etc.) of a size larger than 0.15 mm and smaller than 0.35 mm.

According to some further embodiments, a method of filtering water comprises passing water through the granular filter media having a depth of at least 8 in, at least 9 in, at least 10 in, at least 11 in, at least 12 in, at least 13 in, at least 14 in, at least 15 in, at least 16 in, at least 17 in, at least 18 in, at least 19 in, at least 20 in, at least 25 in, at least 30 in, at least 35 in, at least 40 in, at least 45 in, greater than 50 in, 8 to 25 in, 10 to 25 in, 12 to 25 in, 15 to 25 in, 17 to 25 in, 20 to 25 in, 22 to 25 in, 8 in, 9 in, 10 in, 11 in, 12 in, 13 in, 14 in, 15 in, 16 in, 17 in, 18 in, 19 in, 20 in, 21 in, 22 in, 23 in, 24 in, or 25 in. In some example embodiments a layer of granular filter media can have a depth of 8 in to 60 in.

In some embodiments, a method described herein further comprises a step of passing water through a layer of low density filter media described in Section I, the low density filter media having an effective size that is larger than an effective particle size of a granular filter media. In some instances, a method described herein further comprises a step of passing water through a layer of low density filter media described in Section I, the low density filter media having an effective size that is approximately equal to an effective particle size of a granular filter media.

A method of filtering water described herein can comprise passing water through a column comprising a layer of granular filter media, such as through column 10 shown in FIG. 4. Using FIG. 4 as an example, a method of filtering water through a column can comprise passing water through inlet 11 into column 10, through an optional orifice plate 14, through a layer of granular filter media 13 described in Section I, through an optional fine gravel layer (shown in FIG. 5), and out of the column 10 through outlet 12; and filtering out particles having an average size in three dimensions of 1 μm or larger as the water passes through the layer of granular filter media 13.

Using FIG. 5 as an example, a method of filtering water through a column can comprise passing water through inlet 11 into column 10; through an optional orifice plate 14 (shown in FIG. 4); through an upstream layer of low density filter media described in Section I; through a downstream layer of granular filter media 13 described in Section I; through an optional fine gravel layer 16; and out of the column 10 through outlet 12; and filtering out particles having an average size in three dimensions of 1 μm or larger as the water passes through the layer of granular filter media 13.

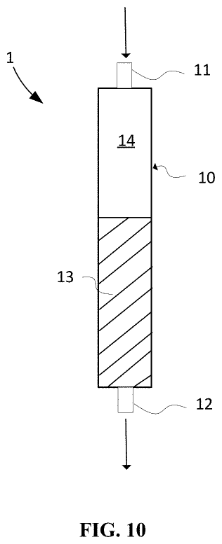

Referring to FIG. 10, a method of filtering water can comprise passing water through a filter system comprising a column 10 and a layer of granular filter media 13. Water can be passed into column 10 through inlet 11 upstream of the granular filter media 13. The water can be passed into the system, for example in the column such that the hydraulic loading rate of the water in the column in an area 14 above the layer of granular filter media 13 is at least 2 gpm/ft². In some instances, the hydraulic loading rate of the water in the column in an area 14 above the layer of granular filter media 13 is up to 12 gpm/ft². It will be appreciated that in some embodiments, water can be supplied or fed to the filter system (e.g. via inlet 11) such as to the column 10 at a rate or velocity sufficient to achieve a hydraulic loading rate of 2-12 gpm/ft². In accordance with embodiments described herein, the granular filter media 13 can have a depth of at least 8 in, for example from 8 in to 60 in.

As previously described herein, the water being filtered can occur in an absence of chemical pretreatment. However, in some embodiments, a method described herein can comprise a step of chemically pretreating water before passing the water through granular filter media. Any chemical pretreatment not inconsistent with the objectives of this disclosure can be used. For example, in some embodiments, chlorine, bromine, or a coagulant can be used, such as an aluminum salt (such as aluminum sulfate or polyaluminum chloride), an iron salt, a titanium salt, a zirconium salt, or other metallic salts, or a cationic polymer.

Some embodiments described herein are further illustrated in the following non-limiting examples. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

### Example 1

### Comparative Columns

A pilot assembly for comparing filter media types was prepared using two, 2″ diameter clear acrylic filter columns. One column was packed with Ceraflow 70™ by Wateropolis Corp, a 0.15-0.25 mm spherical ceramic filter media (“ceramic media”). The second column was packed with various other filter media, such as sand, fine sand, glass microbeads, or zeolite. Each media-packed column was run for extended periods, and column effluent was measured in real time for 2-5 micron sized particles (HACH 2200 PCX), and turbidity was also measured and recorded in real time (GLI Accu4).

### Example 2

### Turbidity

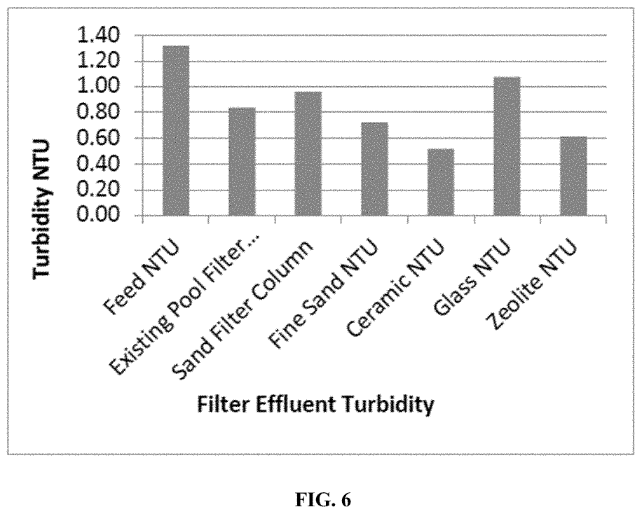

Recreational water from an indoor commercial swimming pool passed through the comparative columns of Example 1 to determine whether various ultrafine granular filter media described herein affected turbidity levels. Baseline pool water influent turbidities during the turbidity test ranged between 0.14 NTU to 2.5 NTU, as depicted in FIG. 6. This variation was correlated to bather load in the pool when the baseline sample was taken. NSF-50 pool media test protocol requires a 70% reduction in effluent turbidity, and, as shown in FIG. 6, an ultrafine granular ceramic media was the only material that achieved at least a 70% reduction in real time test conditions.

### Example 3

### Particle Counts

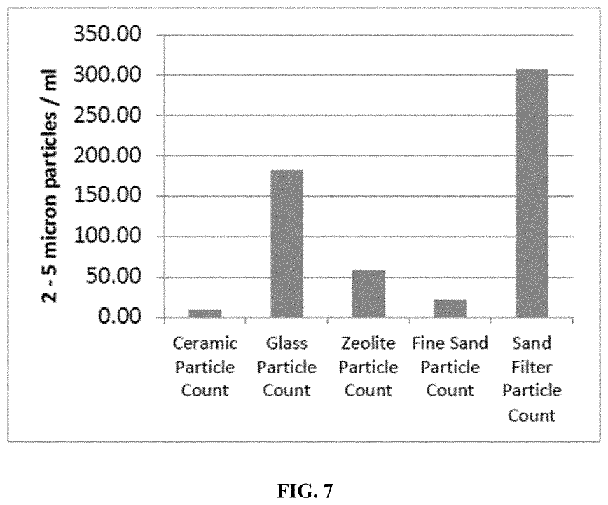

Turbidity removal values generally do not correlate and are not predictive of a filter media's ability to remove Cryptosporidium (“Crypto”) sized particles. Particle count was therefore separately tested by passing recreational water from an indoor commercial swimming pool through the comparative columns and recording at 15 second increments and counting particles in the 2-5 microns (μm) range using a particle counter. This size range was selected based upon the typical size of Cryptosporidium, which are typically larger than 2 microns. Raw influent particle counts were not measured. As shown in FIG. 7, ceramic media effluent particle concentration averaged 9.54 particles per 100/ml, fine grain sand was the next best performing material at 22.1 particles per 100/ml followed by charged zeolite at 58.2 particles per 100/ml.

### Example 4

### Head Loss

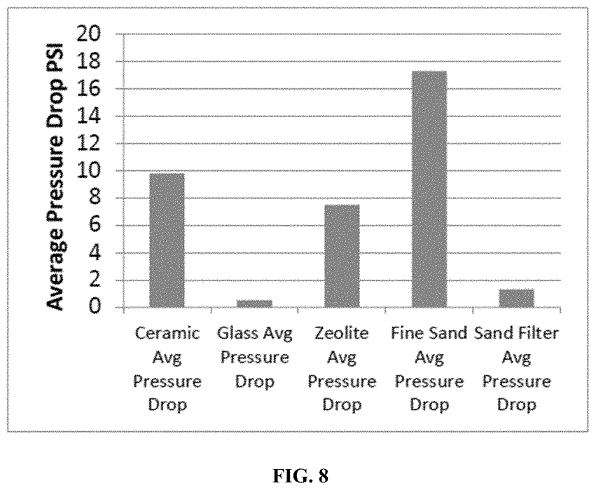

Head loss is an accumulation of pressure across an entire filter bed and is an indicator of filter solids loading. Head loss can be used to predict a need for filter backwashing. In FIG. 8, all filter media tested were installed to identical filter bed depths of 24 inches (610 mm) and all filter columns were run at the same flow rate of 12.0 gpm/ft² (29.3 m/hr) using the comparative columns of Example 1. Head loss for each filter media is shown in FIG. 8, with fine sand showing the greatest average pressure drop, with ceramic and zeolite showing more moderate average pressure drop. Glass microbeads and coarse sand displayed very little pressure drop.

Comparing FIGS. 7 and 8, there is a correlation between average filter head-loss and a filter media's ability to remove crypto sized particles, with the exception of the ceramic media. Surprisingly, the ultrafine granular ceramic media displayed low head loss (FIG. 8) while still displaying low particle effluent counts (FIG. 7).

### Example 5

### 5-Micron Microsphere Removal

Ceramic media was tested side by side against a “charged” zeolite media used in Examples 2-4 that had demonstrated the next best overall filter performance to determine 5-micron microsphere removal properties. Fine sand was excluded from the test due to its overly high-pressure loss characteristics (see FIG. 8). For the test, 5-micron, crypto sized luminescent polystyrene microspheres were dosed at the inlets to the comparative columns of Example 1 at a rate that mimicked a fecal incursion.

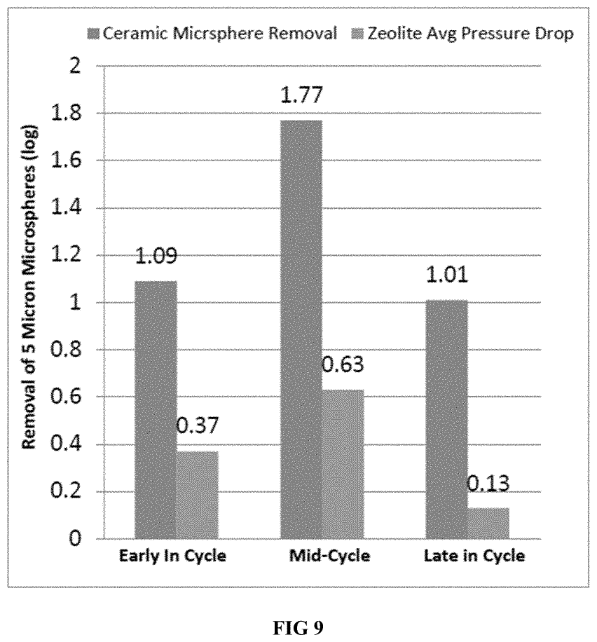

The microsphere testing was done at three points during a typical 7-day continuous filter run. Microspheres were dosed at 3 different times during the filter run, the initial dose at start up before filter “ripening” had occurred. The middle test was done at 3.5 days into the filter run and the final microsphere dose was prior to backwash at the end of the 7 day filter operation. As shown in FIG. 9, zeolite did not perform as well as expected, showing a high of a 0.63 log removal at mid-cycle, and a low of a 0.13 log removal late in the cycle. In contrast, the ceramic filter media provided greater than 1.0 log removal (>90%) removal at all three points in the cycle.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A method of filtering water, comprising:
passing water through a filter system comprising a column and a layer of granular filter media, wherein the hydraulic loading rate of the water in the column above the layer of granular filter media is at least 2 gpm/ft² and wherein the particles of the layer of granular filter media have a size of 0.10 mm to 0.40 mm; and
filtering out materials having an average size in three dimensions of 1 μm or larger.

2. The method of claim 1, wherein the hydraulic loading rate of the water in the column above the layer of granular filter media is up to 12 gpm/ft².

3. The method of claim 1, wherein the layer of granular filter media has a depth of at least 8 inches.

4. The method of claim 1, wherein the granular filter media comprises a ceramic, a sand, a glass, a zeolite, a garnet, an ilmentite, or any combination thereof.

5. The method of claim 1, wherein the granular filter media comprises a ceramic.

6. The method of claim 1, wherein the ceramic granular filter media has a zero or positive zeta potential at a neutral pH.

7. The method of claim 1, wherein the granular filter media comprises a plurality of surface pores having a diameter of 500 nm to 75 μm.

8. The method of claim 1, further comprising passing water through another layer of filter media having a lower density than the granular filter media.

9. The method of claim 8, wherein the layer of granular filter media is a downstream layer and the another layer of filter media is an upstream layer.

10. The method of claim 8, wherein the another layer of filter media has an effective size of 0.5 mm or larger.

11. The method of claim 8, wherein the another layer of filter media comprises a carbonaceous material, a sand, a glass, a zeolite, a ceramic, or any combination thereof.

12. The method of claim 1, wherein the materials comprises microorganisms comprising Cryptosporidium ssp, Giardia ssp, or both.

13. The method of claim 1, wherein the filtering of materials occurs in an absence of chemical pretreatment and/or a biological layer.

14. The method of claim 1, wherein the granular filter media is approximately spherical.

15. The method of claim 1, wherein the layer of granular filter media has a depth of up to 60 in.

16. The method of claim 1, wherein the granular filter media has a porosity of 20% to 60%

17. The method of claim 1, wherein at least 90% of the materials are filtered out of the water.

18. The method of claim 1, wherein 90% of the particles of the layer of granular filter media are larger than 0.15 mm and smaller than 0.35 mm.

19. A method of filtering water, comprising:
passing water through a filter system comprising a column and a layer of granular filter media, wherein the hydraulic loading rate of the water in the column above the layer of granular filter media is at least 2 gpm/ft² and wherein the particles of the layer of granular filter media have an effective size of 0.05 mm to 0.40 mm; and
filtering out materials having an average size in three dimensions of 1 μm or larger.

20. The method of claim 19, wherein the hydraulic loading rate is up to 12 gpm/ft²

21. The method of claim 19, wherein the granular filter media has a depth of at least 8 in.

22. The method of claim 19, further comprising passing the water through a layer of low density filter media having an effective size that is larger than the effective size of the granular filter media.

23. The method of claim 22, wherein the layer of granular filter media is a downstream layer and the layer of low density filter media is an upstream layer.

24. The method of claim 22, wherein the low density filter media has an effective size of 0.5 mm or larger.

25. The method of claim 19, wherein 90% of the materials are filtered out of the water.
